(19) United States
(12) Patent Application Publication
(10) Pub. No.: US 2013/0250853 A1
(43) Pub. Date: Sep. 26, 2013

(54) METHODS AND APPARATUSES TO IMPROVE ROUND TRIP TIME IN TRANSFER CONTROL PROTOCOL USING ACCELERATED ACKNOWLEDGEMENT MESSAGES

(71) Applicant: QUALCOMM INCORPORATED, San Diego, CA (US)

(72) Inventors: Srinivasa R. Eravelli, San Diego, CA (US); Murtuza T. Chhatriwala, San Diego, CA (US); Sivaram Srivenkata Palakodety, San Diego, CA (US)

(73) Assignee: Qualcomm Incorporated, San Diego, CA (US)

(21) Appl. No.: 13/789,505

(22) Filed: Mar. 7, 2013

Related U.S. Application Data
(60) Provisional application No. 61/613,084, filed on Mar. 20, 2012.

(51) Int. Cl. H04W 80/06

(52) U.S. Cl. CPC H04W 80/06
USPC 370/328

(57) ABSTRACT

The present description provides methods and apparatuses for improved transfer control protocol (TCP) acknowledgement transmission during operation of a slow-start process in wireless environments. For example, in an aspect, the present disclosure presents a method of wireless communication, which may include receiving, at a radio network controller (RNC), a transmission control protocol (TCP) packet for a user equipment (UE) from a server. Furthermore, example methods may include reforming the TCP packet into a set of radio link control (RLC) packets. Additionally, in some examples, such methods may additionally include transmitting the set of RLC packets to a base station. Moreover, such methods may include sending an accelerated TCP acknowledgement message to the server based on the transmitting of the set of RLC packets to the base station.

### CLAIM OF PRIORITY UNDER 35 U.S.C. §119

The present application for patent claims priority to Provisional Application No. 61/613,084 entitled “Methods and Apparatuses to Improve Round Trip Time in Transfer Control Protocol Using Accelerated Acknowledgement Messages” filed Mar. 20, 2012, and assigned to the assignee hereof and hereby expressly incorporated by reference herein.

### BACKGROUND

1. Field

Aspects of the present disclosure relate generally to wireless communication systems, and more particularly, to optimizing transfer control protocol (TCP) acknowledgement transmission in a slow-start process.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

TCP is the predominant transport layer protocol in UMTS. TCP utilizes internet protocol (IP) as the network layer. TCP provides a connection-oriented, reliable, byte stream service to the application layer running on top of TCP, wherein “connection-oriented” means that the two end-point devices using TCP must establish a connection with each other before they are able to exchange data. TCP uses sequence numbers to achieve reliability. When TCP sends a segment, it maintains a timer, waiting for the other end to acknowledge reception of the segment. Where the acknowledgement is not received in time, the segment is retransmitted. Whenever a timer at the sender times out waiting for an acknowledgement, the sender changes the congestion window to one segment and starts a “slow-start process.” Furthermore, whenever a TCP end-point starts with the slow-start process, it takes several round-trip times to ramp up to the full capacity of the link. Typically, a time-out is associated with congestion in the network. This is often true in a wired network, which necessitates starting the congestion window at one segment, because this provides the network time to clear any outstanding packets causing the congestion. In a wireless system, however, the timeout is more likely due to loss of the packet than due to congestion. Additionally, the round-trip times in a wireless system are orders of magnitude higher than in a wired network. Because of this, whenever a TCP end-point starts with the slow-start process in a wireless network, the slow-start process may have a significant impact on overall user experience.

To avoid sender time-outs due to missing acknowledgements, Wireless Wide Area Networks (WWANs) have a link layer protocol that ensures reliability: the Radio Link Control (RLC). This protocol provides reliability in a WCDMA system and hides the TCP/IP layer from packet losses. In operation, a TCP/IP packet is chopped up into one or more RLC PDUs by the sending RLC entity. The RLC layer maintains its own sequence numbers and acknowledgements. When an acknowledgement is not received by the sending RLC radio network controller (RNC) or a negative acknowledgement is received, the RNC retransmits the RLC packet. One of the purposes of utilizing the RLC layer is to hide the TCP layer from wireless media access control (MAC) layer errors. A typical wireless system is configured to have certain error rates at the MAC layer to strike a balance between achieving reliability versus scalability in terms of number of users supported. For example, if the MAC layer is configured to have a one percent block error rate (BLER), then one percent of the packets are not successfully decoded by the receiver. These unsuccessfully-decoded packets go through RLC layer retransmissions. Without an RLC layer and its retransmissions, these one percent of packets would result in TCP time-outs, which would have an adverse impact on the TCP user experience. Thus, the RLC layer hides the TCP layer from TCP timeouts and retransmissions. However, since there can be multiple transmissions and/or retransmissions at the RLC layer to send the RLC packets that make up the TCP packet, such multiple transmissions or retransmissions change a timing of when a TCP acknowledgement is transmitted to and received at the server. In other words, the TCP acknowledgement is not sent to the server until all of the RLC packets making up the TCP packet are acknowledged. So, the multiple transmissions and/or retransmissions introduce what is called Round Trip Time (RTT) fluctuations. This may potentially have severe impact on the overall performance of TCP and end-user-experience.

Furthermore, the RTT fluctuations affect the slow-start process. The slow-start process operates by setting the rate at which new packets are to be injected into the network to the rate at which the acknowledgements are returned by the receiving device, for example, a user equipment (UE). In addition, the slow-start process adds another window to the TCP of the sender: the congestion window. When a new connection is established with a host on another network, the congestion window is initialized to one segment. Each time an acknowledgement message (ACK) is received, the congestion window is increased by one segment. The sender can transmit a number of segments up to the minimum of the congestion window and the advertised window. The congestion window is flow control imposed by the sender, while the advertised window is flow control imposed by the receiver.

In operation of the slow-start process, the sender begins by transmitting a number of segments equal to an initial window size and waiting for the ACK. When that ACK is received, the congestion window is incremented by the initial window size and twice the number of segments as that of the initial window size can be sent. For example, with an initial window size of one segment and an increased window size of two segments, when both of these segments are acknowledged, the congestion window may be increased by four times, which may correspond to an exponential increase. This exponential increase happens until the congestion window reaches a threshold value. Once the congestion window crosses this threshold value, a congestion avoidance algorithm is utilized and a congestion avoidance phase is initiated. During such a congestion avoidance phase, the congestion window (“cwnd”) is incremented by 1/cwnd each time an ACK is received. Thus, this is an additive increase, compared to the exponential increase associated with the slow-start process.

For example, assuming that the initial threshold value is 65,535 bytes and the Maximum Segment Size (MSS) is around 1500 bytes, it takes six round-trips to reach the threshold value and for the congestion avoidance algorithm to be initiated. During the slow-start process, the link capacity is not fully utilized. For example, where the round trip time to the server is around 100 ms then it takes more than half a second before the link can be fully utilized. In a web-browsing session each time a user requests a page, a new TCP connection is established. Since an average web-page is around 300 KB in size, much more time is spent in the TCP slow-start process than in the congestion avoidance phase. Therefore, methods and apparatuses for reducing time in the slow-start process by reducing round trip time for TCP packets are desired to improve the overall user experience.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents methods and apparatuses for optimizing TCP acknowledgement transmission in a TCP slow-start process in a wireless communication environment. For example, in an aspect, the present disclosure presents a method of wireless communication, which may include receiving, at a radio network controller, a transmission control protocol packet for a user equipment from a server. Furthermore, example methods may include reforming the TCP packet into a set of radio link control packets, transmitting the set of RLC packets to a base station, and sending an accelerated TCP acknowledgement message to the server based on the transmitting of the set of RLC packets to the base station.

Additionally, the present disclosure presents an apparatus for wireless communication, which may include means receiving, at a radio network controller, a transmission control protocol packet for a user equipment from a server. In addition, the apparatus may include means for reforming the TCP packet into a set of radio link control packets, means for transmitting the set of RLC packets to a base station, and/or means for sending an accelerated TCP acknowledgement message to the server based on the means for transmitting the set of RLC packets to the base station.

In an additional aspect, the present disclosure describes a computer program product, which may include a computer-readable medium that includes code for receiving, at a radio network controller, a transmission control protocol packet for a user equipment from a server. Additionally, the computer-readable medium may include code for reforming the TCP packet into a set of radio link control packets, code for transmitting the set of RLC packets to a base station, and/or code for sending an accelerated TCP acknowledgement message to the server based on the transmitting the set of RLC packets to the base station.

Furthermore, the present disclosure presents an apparatus for wireless communication, which may include at least one processor and a memory coupled to theat least one processor, where the at least one processor is configured to receive, at a radio network controller, a transmission control protocol packet for a user equipment from a server. In addition, the at least one processor may be configured to reform the TCP packet into a set of radio link control packets, transmit the set of RLC packets to a base station, and send an accelerated TCP acknowledgement message to the server based on the transmitting the set of RLC packets to the base station.

These and other aspects of the disclosure will become more fully understood upon a review of the detailed description, which follows.

### BRIEF DESCRIPTION OF THE DRAWINGS

FIG. 1 is a system-level diagram illustrating devices for improving round trip time for an optimized slow-start process in TCP in a wireless system;

FIG. 2 is a block diagram of a generic computer device according to aspects of the current description;

FIG. 3 is a flow chart of an example methodology for decreasing round trip time for TCP packets in a wireless system;

FIG. 4 is a flow chart of a further aspect of the methodology of FIG. 3;

FIG. 5 is a message flow diagram of an example use case according to aspects of the current description;

FIG. 6 is an electrical component block diagram according to aspects of the present disclosure;

FIG. 7 is a block diagram illustrating an example of a hardware implementation for an apparatus employing a processing system;

FIG. 8 is a block diagram conceptually illustrating an example of a telecommunications system;

FIG. 9 is a conceptual diagram illustrating an example of an access network.

FIG. 10 is a conceptual diagram illustrating an example of a radio protocol architecture for the user and control plane; and

FIG. 11 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

According to the present disclosure, the round trip time (RTT) for TCP packets may be lessened, for example, to improve a TCP slow-start process in UMTS. In an aspect, a radio network controller (RNC) may establish a TCP session with a server and one or more base stations and/or user equipment in a wireless environment. As noted above, the round trip time of a TCP packet may be detrimentally extended by RLC level multiple transmissions and/or retransmission of data packets from the RLC layer to the one or more UEs through the base station. Because the RTT of packets is defined at the time from the initial transmission of the TCP packet from the server to the time of receipt of an acknowledgement of correct reception and decoding of the TCP packet from the UE at the server, generating an “accelerated” TCP acknowledgement (ACK) message at the RNC and transmitting this accelerated TCP ACK to the server may reduce RTT. Such an accelerated TCP ACK may also be referred to as a fake TCP ACK. For example, in an aspect of the present disclosure, the RNC may generate the accelerated TCP ACK at the time that the TCP packet has been broken down into multiple RLC packets and these RLC packets are sent to a base station for transmission to a UE. Specifically, transmitting such an accelerated TCP ACK before the UE correctly receives all RLC packets, generates a TCP acknowledgement message, and sends the TCP acknowledgement message to the RNC for forwarding to the server, will speed up the slow-start process by negating round trip time delay that may occur due to multiple transmissions and/or retransmissions of RLC packets between the RNC and the destination UE. Thus, by speeding up the slow-start process, the network gets to the full pipe stage faster, e.g., is able to more quickly utilize the full link capacity, which may improve the overall user experience.

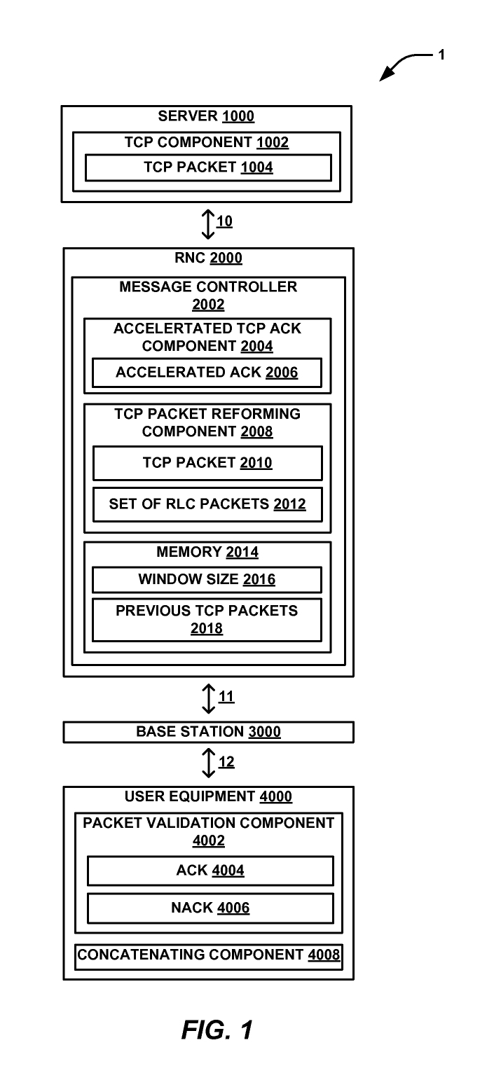

Referring to FIG. 1, a wireless communication system 1 is illustrated that enables reduction of round trip time (RTT) in packet communication and an ability to more quickly utilize a full link capacity in a TCP slow-start process. System 1 may include, for example, a server 1000, a radio network controller (RNC) 2000, and one or more base stations 3000 that may serve one or more user equipment (UE) 4000. In an aspect, server 1000 may generate, store, transmit, and/or receive one or more TCP packets 1004 in TCP component 1002. In an aspect, though not shown explicitly in FIG. 1, server 1000 may receive TCP packets 1004 from a core network. Furthermore, server 1000 may communicate with RNC 2000 via communication link 10.

In addition, system 1 may include RNC 2000, which may be configured to receive TCP packet 1004 and send a corresponding accelerated TCP acknowledgement message 2006 to server 1000. According to the present disclosure, the accelerated TCP acknowledgement 2006 is termed “accelerated” because the accelerated TCP message according to the present disclosure may be sent before a destination UE receives, decodes, and sends an acknowledgement for the TCP packet, which is the legacy TCP acknowledgement procedure. In an aspect, RNC 2000 may include a message controller 2002, which may be configured to receive, transmit, process, and/or control TCP and/or RLC messages or packets. Additionally, message controller 2002 may include an accelerated TCP acknowledgement (ACK) component 2004, which may be configured to generate and transmit the accelerated TCP acknowledgement message 2006 to, for example, server 1000. In a further aspect, message controller 2002 may include a TCP packet reforming component 2008, which may be configured to reform the received and stored TCP packet 1004 by breaking down or disassembling the TCP packet 1004 and forming a set of RLC packets 2012 from the disassembled TCP packet 1004. In an aspect, the set of RLC packets 2012 may be sent to a destination UE (e.g., UE 4000) once the set of RLC packets 2012 is formed.

Furthermore, RNC 2000 may include a memory 2014, which may store a window size parameter 2016 and/or previously-received and/or processed TCP packets 2018. In an aspect, window size parameter 2016 includes a previously-determined window size parameter. For instance, one example that should not be construed as limiting, message controller 2002 of RNC 2000 is configured to intercept or otherwise monitor a TCP connection establishment phase between server 1000 and UE 4000 and store an initial UE advertised window size parameter sent by UE 4000 during the TCP connection establishment phase. As such, in this case, the previously-determined window size parameter is the initial UE advertised window size parameter, which RNC 2000 and/or message controller 2002 may use when sending an initial accelerated TCP acknowledgement message 2006 to server 1000. In another example that should not be construed as limiting, message controller 2002 of RNC 2000 may receive a TCP acknowledgement message corresponding to previous TCP packet 2018 from base station 3000 and/or UE 4000, which may include a window size parameter. In an aspect, for example, the previous TCP packet 2018 in this case may be the most recent TCP packet prior to current TCP packet 1004. As such, in this case, the previously-determined window size parameter is the window size parameter from the TCP acknowledgement message corresponding to previous TCP packet 2018, which RNC 2000 and/or message controller 2002 may use when sending a subsequent accelerated TCP acknowledgement message 2006 to server 1000. Furthermore, the stored ones of previous TCP packets 2018 may be utilized in retransmission processes and/or after an RLC reset procedure to ensure that TCP packets not received by the UE 4000 may be retransmitted thereto. For example, in an aspect, RNC 2000 and/or an RLC layer thereof may be set to operate according to the RLC reset procedure configured to re-initiate retransmissions of an RLC packet when a configured maximum number of transmissions of the RLC packet is reached. Moreover, RNC 2000 may be further configured to send the accelerated TCP acknowledgement message 2006 based on the operating of the RLC layer according to the RLC reset procedure.

In addition, system 1 may include base station 3000, which may be configured to receive one or more signals, which may include a set of RLC packets 2012 transmitted by RNC 2000 via communication link 11. Base station 3000 may forward the set of RLC packets 2012 to user equipment 4000. Furthermore, base station 3000 may be configured to receive RLC ACK and/or not-acknowledged (NACK) messages, as well as TCP acknowledgement messages, from user equipment 4000 over communication link 12 and may forward these messages to RNC 2000 over communication link 11. For example, the RLC ACK/NACK messages relate to each of the sets of RLC packets 2012, while the TCP acknowledgement messages relate to reception of the full set of RLC packets 2012, e.g. the TCP packet 1004.

In a further aspect, system 1 may include user equipment (UE) 4000, which may be configured to receive, decode, validate, concatenate, and/or otherwise process one or more RLC packets from a set of RLC packets 2012 transmitted by RNC 2000. For example, UE 4000 may include a packet validation component 4002, which may be configured to decode and process each packet in a set of RLC packets 2012 transmitted by RNC 2000. Where UE 4000 determines that a packet has been correctly received, packet validation component 4002 may transmit an acknowledgement message (ACK) 4004 to base station 3000 for forwarding to RNC 2000. For example, in one aspect, ACK 4004 may be an RLC ACK to acknowledge receipt of one of the set of RLC packets 2012, while in another aspect ACK 4004 may a TCP ACK to acknowledge receipt of the full set of RLC packets 2012, e.g. the TCP packet 1004. Conversely, where packet validation component 4002 determines that a packet has not been correctly received, packet validation component 4002 may transmit a NACK message 4006 to base station 3000 for forwarding to RNC 2000. For example, in one aspect, NACK 4006 may be an RLC NACK to indicate that one of the set of RLC packets 2012 has not been received. In addition, packet validation component 4002 may be configured to transmit a window size parameter 2016, for example in ACK message 4004, e.g. in the TCP packet ACK, which also may be referred to as a UE acknowledgement message. Specifically, in an aspect, packet validation component 4002 may transmit ACK message 4004 including window size parameter 2016 to base station 3000 for forwarding to RNC 2000 when UE 4000 determines that all packets corresponding to a full TCP packet, e.g. the full set of RLC packets 2012, have been correctly received by UE 4000. Thus, in an aspect, window size parameter 2016 may be included with TCP acknowledgement data in a UE acknowledgement message, e.g. TCP version of ACK message 4004, which may be stored by RNC 2000 for use inclusion in a next accelerated TCP acknowledgement message upon receipt of a subsequent TCP packet from server 1000.

Furthermore, UE 4000 may include concatenating component 4008, which may be configured to concatenate the set of RLC packets 2012 received from RNC 2000 through base station 3000 to at least partially form TCP packet 1004 originally transmitted from server 1000. In an aspect, where the concatenation performed by concatenating component 4008 results in a fully- and correctly-received TCP packet composed of the set of RLC packets 2012, packet validation component 4002 may transmit a UE acknowledgement message, such as a TCP version of ACK 4004, to RNC 2000 through base station 3000.

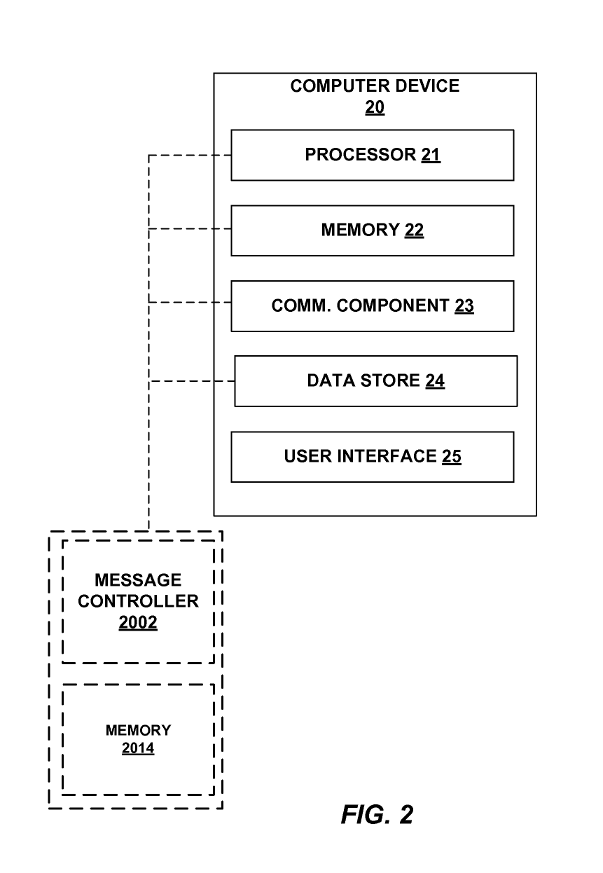

Referring to FIG. 2, in one aspect, any of server 1000, RNC 2000, base station 3000, and UE 4000 (FIG. 1) may be represented by a specially programmed or configured computer device 20. Computer device 20 includes a processor 21 for carrying out processing functions associated with one or more of components and functions described herein. Processor 21 can include a single or multiple set of processors or multi-core processors. Moreover, processor 21 can be implemented as an integrated processing system and/or a distributed processing system.

Computer device 20 further includes a memory 22, such as for storing data used herein and/or local versions of applications being executed by processor 21. Memory 22 can include any type of memory usable by a computer, such as random access memory (RAM), read only memory (ROM), tapes, magnetic discs, optical discs, volatile memory, non-volatile memory, and any combination thereof.

Further, computer device 20 includes a communications component 23 that provides for establishing and maintaining communications with one or more parties utilizing hardware, software, and services as described herein. Communications component 23 may carry communications between components on computer device 20, as well as between computer device 20 and external devices, such as devices located across a communications network and/or devices serially or locally connected to computer device 20. For example, communications component 23 may include one or more buses, and may further include transmit chain components and receive chain components associated with a transmitter and receiver, respectively, or a transceiver, operable for interfacing with external devices. In an additional aspect, communications component 23 may be configured to receive one or more pages from one or more subscriber networks. In a further aspect, such a page may correspond to the second subscription and may be received via the first technology type communication services.

Additionally, computer device 20 may further include a data store 24, which can be any suitable combination of hardware and/or software, that provides for mass storage of information, databases, and programs employed in connection with aspects described herein. For example, data store 24 may be a data repository for applications not currently being executed by processor 21.

Computer device 20 may additionally include a user interface component 25 operable to receive inputs from a user of computer device 20, and further operable to generate outputs for presentation to the user. User interface component 25 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 25 may include one or more output devices, including but not limited to a display, a speaker, a haptic feedback mechanism, a printer, any other mechanism capable of presenting an output to a user, or any combination thereof. In an additional aspect, a user using the user interface 25 may set one of a first subscription or a second subscription as a dedicated data service (DDS) for the computer device 20.

In a network device implementation, such as for RNC 2000 of FIG. 1, computer device 20 may include message controller 2002, such as in specially programmed computer readable instructions or code, firmware, hardware, or some combination thereof. Further, in another network device implementation, such as for server 1000 of FIG. 1, computer device 20 may include TCP component 1002, such as in specially programmed computer readable instructions or code, firmware, hardware, or some combination thereof. Additionally, in a mobile device implementation, such as for UE 4000 of FIG. 1, computer device 20 may include packet validation component 4002 and concatenating component 4008, such as in specially programmed computer readable instructions or code, firmware, hardware, or some combination thereof.

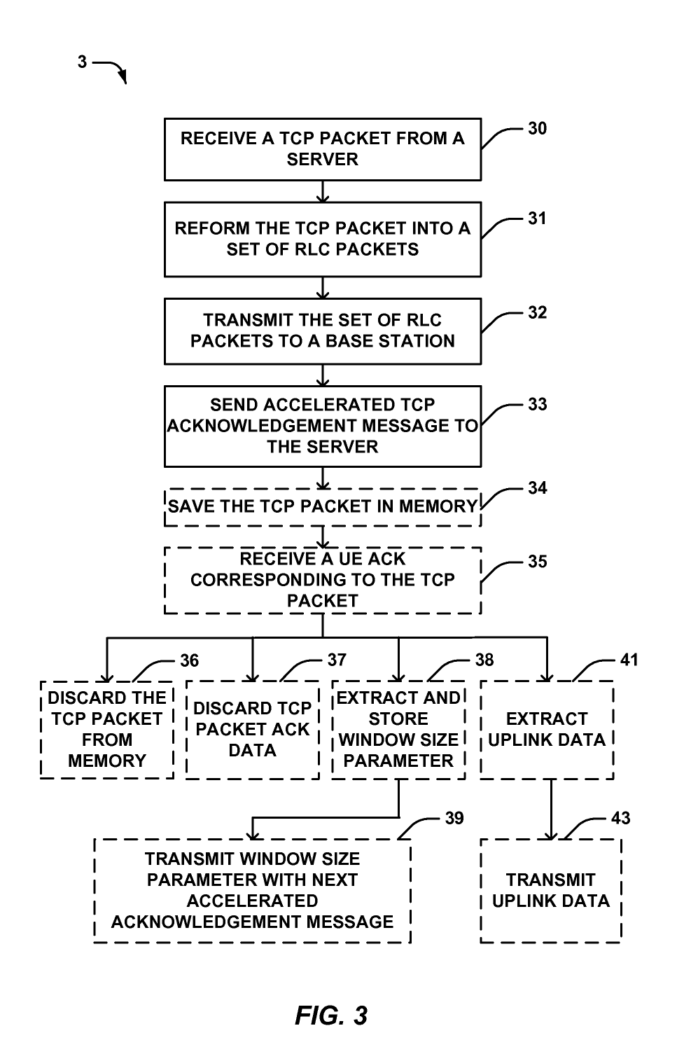

Referring to FIG. 3, an example methodology 3 for reducing round trip time for TCP packets in a wireless system is illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

In an aspect, at block 30, a RNC may receive a TCP packet from a server. The TCP may include a destination device, such as a user equipment (UE) in a wireless environment. In addition, at block 31, the RNC may reform the received TCP packet into a set of RLC packets. In an aspect, the RNC may establish and utilize a TCP-RLC layer correlation instance by which TCP packet information it passed to the RLC layer for subsequent transmission to a UE and processing. In a further aspect, the RNC may transmit the set of RLC packets to a base station at block 32. Once the RLC packets have been transmitted by the RNC, the RNC may send an accelerated TCP acknowledgement message to the server at block 33. By sending the accelerated TCP acknowledgement to the server prior to receiving an acknowledgement for those RLC packets sent to the UE, the RNC may decrease round trip time for the TCP packet sent from the server and may correspondingly accelerate operation of the slow-start process in a wireless system.

For example, the RNC may send the accelerated TCP acknowledgement message with a previously-determined window size parameter. For instance, in one aspect, the RNC may intercept a TCP connection establishment phase and store an initial UE advertised window size parameter. For example, the RNC may be configured to sniff TCP packets within the RNC and identify the initial UE advertised window size parameter during the three way hand-shake phase of the TCP connection establishment. As such, in this case, the initial UE advertised window size parameter comprises the previously-determined window size parameter, such that the RNC sending the accelerated TCP acknowledgement message further comprises sending with the initial UE advertised window size. In another example, the RNC may receive an acknowledgement message corresponding to a prior TCP packet sent to the UE, wherein the acknowledgement message includes a window size parameter. In this case, the window size parameter from the acknowledgement message corresponding to the prior TCP packet comprises the previously-determined window size parameter. As such, the RNC sending the accelerated TCP acknowledgement message further comprises sending with the window size parameter from the acknowledgement message corresponding to the prior TCP packet.

Further, optional aspects of the present disclosure are represented in FIG. 3 by dashed block perimeter lines. For example, at block 34, the RNC may save the TCP packet in memory at block 34, which may be implemented in the case the retransmission of the TCP packet and/or one or more RLC packets must be retransmitted. Additionally, at block 35, the RNC may receive a UE ACK corresponding to the TCP packet composed of the concatenated RLC packets at the UE. This UE ACK may include one or more of a window size parameter, TCP packet acknowledgement information, and optionally uplink data. For example, the window size parameter may be a current advertised window size supported by UE 4000. Further, for example, the TCP acknowledgement information may include, but is not limited to, an acknowledgement sequence number, for example, corresponding to a particular set of RLC packets 2012 that have been received. Also, for example, the uplink data may be actual data bytes (as opposed to information that would be in a header) including, but not limited to, a request for a webpage, TCP data bytes sent in the uplink, and other such type of data. As a result of receiving this UE ACK, in an aspect, the RNC may discard the TCP packet from the RNC memory at block 36, as the RNC is aware that the UE has correctly received the TCP data and retransmission is likely unnecessary.

Furthermore, unlike legacy RNC procedures, which would forward this UE ACK to the server at upon receipt of the UE ACK message from the UE, the RNC of the present disclosure has previously sent the accelerated TCP ACK message to the server at block 33. Therefore, the TCP packet acknowledgement data, which may indicate that the TCP packet has been correctly received at the UE, is not needed. Thus, in an aspect, the RNC may discard the TCP packet acknowledgement data at block 37. In a further aspect, at block 38, the RNC may extract and store the window size parameter from the received UE ACK message. Additionally, at block 39, the RNC may add the window size parameter to the next accelerated TCP acknowledgement message sent to the server. As such, the server will have an approximate window size parameter to include in its next TCP packet transmission to the RNC. In an additional aspect, at blocks 41 and 43, in a case where the UE ACK message includes uplink data, the RNC may extract the uplink data and then transmit the uplink data to the server, such as in a TCP message.

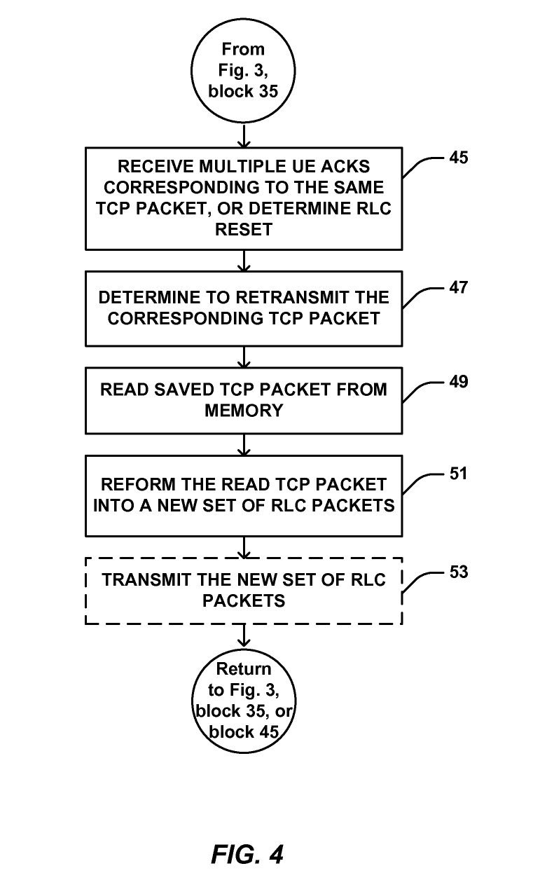

Referring to FIG. 4, in an additional optional aspect of the present disclosure, method 3 may continue from block 35 in FIG. 3 to operate in a retransmit mode. For example, in some cases, at block 45, the RNC may receive multiple UE acknowledgement messages from the UE corresponding to the same TCP packet, or the RNC may determine there is an RLC reset, e.g., based upon an RLC layer of RNC reaching a maximum number of retransmissions of one or more of the set of RLC packets. Accordingly, at block 47, the RNC may determine to retransmit the corresponding TCP packet data to the UE. As such, at block 49, the RNC may read the saved version of the corresponding TCP packet from the RNC memory. From this read TCP packet, at block 51, the RNC may reform the TCP packet read from the memory into a new set of RLC packets. Further, at block 53, the RNC may transmit this new set of RLC packets to the base station, which may in turn forward the set of RLC packets to the destination UE. At this point, the method may return to block 35 of FIG. 3, or to block 45 of FIG. 4, depending on what acknowledgements are subsequently received.

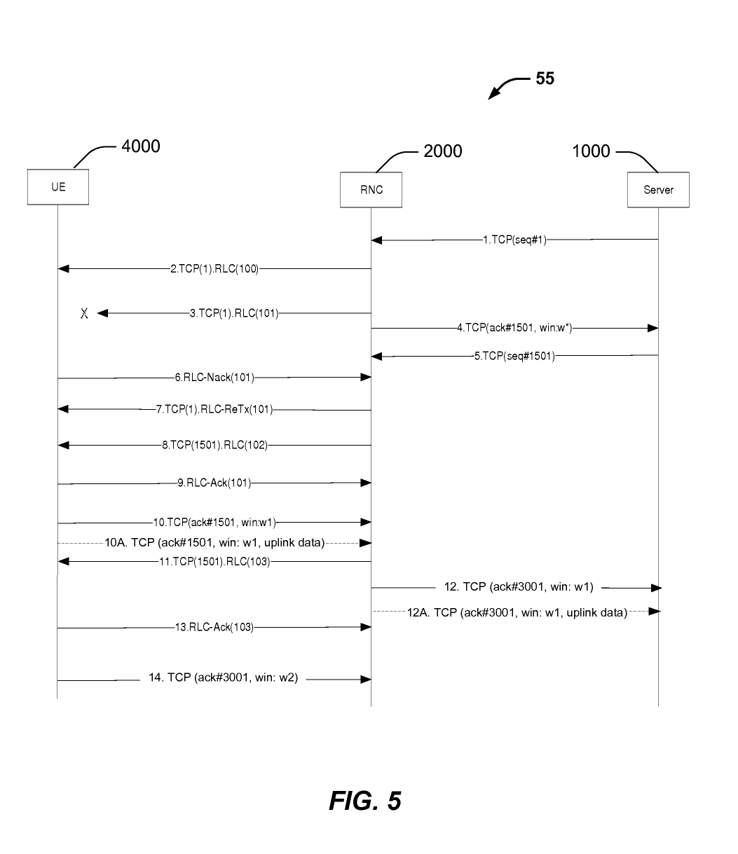

Referring to FIG. 5, in a use case that should not be construed as limiting, a message flow 55 represents one aspect of an operation of the present apparatus and methods. Message flow 55 assumes that the RLC reset procedure is selected by the RRC layer of RNC 2000. For purposes of background, it is noted that the RLC layer of RNC 2000, in WCDMA, is designed to retransmit the packets until a configured max number of transmissions (MAXDAT) is reached. If the packet cannot be delivered after (MAXDAT-1) transmissions then either the corresponding packet is discarded or the RLC layer is reset, e.g., to re-attempt delivery of the packet. If the RLC layer reset is selected, then the TCP acknowledgement is in a way redundant. As such, according to the present aspects, the RNC layer of RNC 2000 can assume that the packet will be successfully delivered, and send a fake TCP acknowledgement to the server 1000. As such, the following message flow 55 describes an aspect of the present apparatus and methods. Also, please note that message flow 55 assumes that the TCP connection is established prior to step 1.

At step 1, the server 1000 is sending a TCP packet with sequence number 1. In an aspect, the amount of data received at the RNC 2000 from the server 1000 in each TCP packet is 1500 bytes, with the first such TCP packet containing a sequence number of 1. This packet gets to RNC 2000 and is broken up into 2 RLC PDUs with sequence numbers 100 and 101. At steps 2 and 3, both these RLC PDUs are forwarded to the nodeB (which is not shown in this diagram for simplicity), which in turn sends them to the UE 4000. Further, according to the present apparatus and methods, at step 4, as soon as the TCP packet is chopped up into RLC packets and sent to the nodeB, the accelerated TCP acknowledgement is sent to the server 1000. In this case, as noted herein, RNC 2000 may have previously monitored the connection establishment messages from UE 4000 to server 1000 and intercepted or otherwise acquired an initial window size parameter, e.g. “win: w”, of UE 4000 to use in this initial accelerated TCP acknowledgement sent in step 4. Moreover, the accelerated TCP acknowledgement at step 4 may include TCP acknowledgement information, such as an acknowledgement sequence number, e.g., “ack#1501” in this case. For example, in an aspect, the present apparatus and methods determined the acknowledgement sequence number for the accelerated TCP acknowledgement according to the equation: sequence number (x)+data length; so, in the case of the first TCP packet, e.g. sequence #1, having a data length of 1500 bytes, the acknowledgement sequence number is “1501.”

In any case, this enhanced method of transmitting accelerated TCP acknowledgement removes all the time variations associated with multiple retransmissions of the RLC PDUs at the MAC level and at the RLC level. This method also reduces the RTT quite a bit and removes or reduces big fluctuations in the RTT. The RTT in this case as perceived by the server 1000 is made up of two components: Time taken from server 1000 to the RNC 2000 and time taken from RNC 2000 to the UE 4000. With the present apparatus and methods, the time taken from RNC 2000 to the UE 4000 is removed from the equation. Further, for example, if the transmit queue of RNC 2000 is congested, then it might take RNC 2000 longer to split the TCP packet into multiple RLC packets. This is reflected in this enhanced method, as the TCP acknowledgement is sent after the RLC packets are sent out from RNC 2000 to the nodeB.

In this example, referring to steps 3 and 7, RLC PDU with sequence number 101 goes through a re-transmission, with step 3 representing a transmission not received by UE 4000 and step 6 being the corresponding RLC-NACK.

In the meantime, at step 5, server 1000 transmits the next TCP packet, e.g. having sequence number 1501 (which represents the next byte of data following the initial 1500 byte packet of data). As such, the present aspects have expedited the transmission of the next TCP packet from the server 1000 by sending out the accelerated TCP acknowledgement after the initial TCP packet was broken up into the two RLC packets and transmitted to the UE 4000 at steps 2 and 3. Accordingly, the RNC 2000 breaks up the next TCP packet, e.g. sequence number 1501, into 2 RLC PDUs with sequence numbers 102 and 103. At steps 8 and 11, both these RLC PDUs are forwarded to the nodeB (not shown), which in turn sends them to the UE 4000.

At step 9, once both the RLC PDUs that make the TCP packet with sequence number 1 are received by the UE 4000, the UE 4000 sends an RLC acknowledgement, e.g. “RLC-ACK (101),” to RNC 2000. Further, the UE 4000 forwards the packet to the socket layer on the UE. At step 10, the socket layer of UE 4000 sends a TCP acknowledgement to the RNC 2000, which in this aspect may include the acknowledgement sequence number, e.g. “ack#1501,” and the current advertised window parameter, e.g. “win: w1.” Optionally, in another aspect, at step 10A, the TCP acknowledgement may additionally include uplink data. In either case, the RNC 2000 updates and stores the TCP acknowledgement sequence number, e.g., “ack#3001,” and extracts and stores the current advertised window parameter, e.g. “win: w1,” for use in the next accelerated acknowledgement, e.g., referring to the accelerated acknowledgement sent in step 12 after the last RLC PDU of TCP packet seq#1501 is transmitted to UE 4000 in step 11.

Specifically, at step 12, in the aspect of the TCP acknowledgement without uplink data, the RNC 2000 forwards the TCP acknowledgement with acknowledgement sequence number “ack#3001” and the current advertised window parameter “win: w1” to the server 1000.

At optional step 12A, which corresponds to optional step 10A, the RNC 2000 forwards the TCP acknowledgement with acknowledgement sequence number “ack#3001,” the current advertised window parameter “win: w1,” and the uplink data to the server 1000.

At step 13, once both the RLC PDUs (e.g., 102 and 103) that make the TCP packet with sequence number 1501 are received by the UE 4000, the UE 4000 sends an RLC acknowledgement, e.g. “RLC-ACK (101),” to RNC 2000. Further, the UE 4000 forwards the packet to the socket layer on the UE. At step 14, the socket layer of UE 4000 sends a TCP acknowledgement to the RNC 2000, which in this aspect may include the acknowledgement sequence number, e.g. “ack#3001,” and the current advertised window parameter, e.g. “win: w2.” Although not illustrated, the RNC 2000 may extract and update the acknowledgement sequence number, and extract and save the current advertised window parameter, e.g. “win: w2.”

In this example, the TCP packet with sequence number 1501 does not go through retransmissions, and, as such, gets a TCP acknowledgement (e.g., at step 12 or step 12A) sooner than the TCP packet with sequence number 1.

It should be noted that there may be H-ARQ level re-transmissions at the nodeB. These are not shown in the FIG. 5. For example, in an aspect, some MAC-ehs packets can go through in one attempt and some can take several retransmissions. When the MAC-ehs retransmissions, the MAC-e retransmissions in the uplink where the TCP acknowledgement is sent, and the RLC retransmissions are taken into account, there is quite a bit of variation in the TCP RTT as perceived by the server 1000 when the present apparatus and methods are not implemented. This variation not only makes it longer for TCP to go through the slow-start process, but also increases the Retransmission Timeout (RTO) value. The RTO is how long the server waits for an acknowledgement before retransmitting a packet. With a larger RTO, the user experience further deteriorates when there is a packet outage. As such, the present apparatus and methods provide an enhanced method by generating the accelerated TCP acknowledgement, as described herein, thereby avoiding the above-noted RTT and RTO issues related to H-ARQ level re-transmissions at the nodeB.

One might ask, what would happen if the RLC packets that make up a TCP packet are successfully delivered to the UE, but then dropped between the WCDMA protocol stack on the UE and the IP stack. In this case, the TCP ACK would have already been sent to the server and as a result the TCP stack at the server would have flushed the packets. Since RLC is successfully delivered, the RLC layer would have flushed these packets. The present apparatus and methods are configured to recover these packets by maintaining a queue, e.g., memory 2014, to keep all the TCP packets, e.g., previous TCP packets 2018, at the RNC 2000. All incoming TCP packets are enqueued in this queue. Whenever a TCP ACK is received from the UE 4000, the corresponding TCP packet is removed from this queue. If three or more consecutive TCP acknowledgements are received from the UE 4000, then this is a signal to the RNC 2000 that the corresponding TCP packet is not received by the UE 4000. In response, the RNC 2000 re-segments the TCP packet into multiple RLC packets and sends all of them. Since there is duplicate detection at the TCP layer at the UE 4000, the UE 4000 should be able to drop redundant packets. As such, the UE 4000 should be able to build the original TCP packet from packets that were received before in combination with the newly received packets and construct a TCP packet out of them.

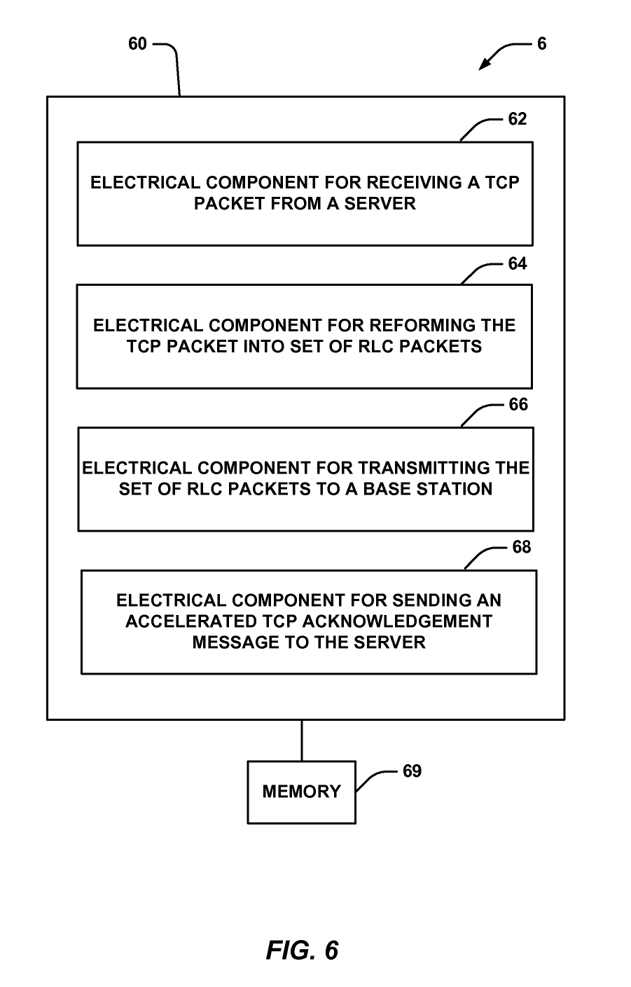

Referring to FIG. 6, an example system 6 is displayed for optimized Fast Dormancy in UMTS. For example, system 4 can reside at least partially within one or more network entities. It is to be appreciated that system 6 is represented as including functional blocks, which can be functional blocks that represent functions implemented by a processor, software, or combination thereof (e.g., firmware). System 5 includes a logical grouping 60 of electrical components that can act in conjunction. For instance, logical grouping 60 can include an electrical component 62 for receiving a TCP packet from a server. In an aspect, electrical component 62 may comprise communications component 23. In an additional aspect, logical grouping 60 can include an electrical component 64 for reforming the TCP packet into a set of RLC packets. In an aspect, electrical component 64 may comprise TCP packet reforming component 2008 (FIG. 1). In a further aspect, logical grouping 60 can include an electrical component 66 for transmitting the set of RLC packets to a base station. In an aspect, electrical component 66 may comprise communications component 23 (FIG. 2). In a further aspect, logical grouping 60 can include an electrical component 68 for sending an accelerated TCP acknowledgement message to the server. In an aspect, electrical component 68 may comprise accelerated TCP ACK component 2004 (FIG. 1).

Additionally, system 6 can include a memory 69 that retains instructions for executing functions associated with the electrical components 62, 64, 66, and 68, stores data used or obtained by the electrical components 62, 64, 66, and 68, etc. While shown as being external to memory 69, it is to be understood that one or more of the electrical components 62, 64, 66, and 68 can exist within memory 69. In one example, electrical components 62, 64, 66, and 68 can comprise at least one processor, or each electrical component 62, 64, 66, and 68 can be a corresponding module of at least one processor. Moreover, in an additional or alternative example, electrical components 62, 64, 66, and 68 can be a computer program product including a computer readable medium, where each electrical component 62, 64, 66, and 68 can be corresponding code.

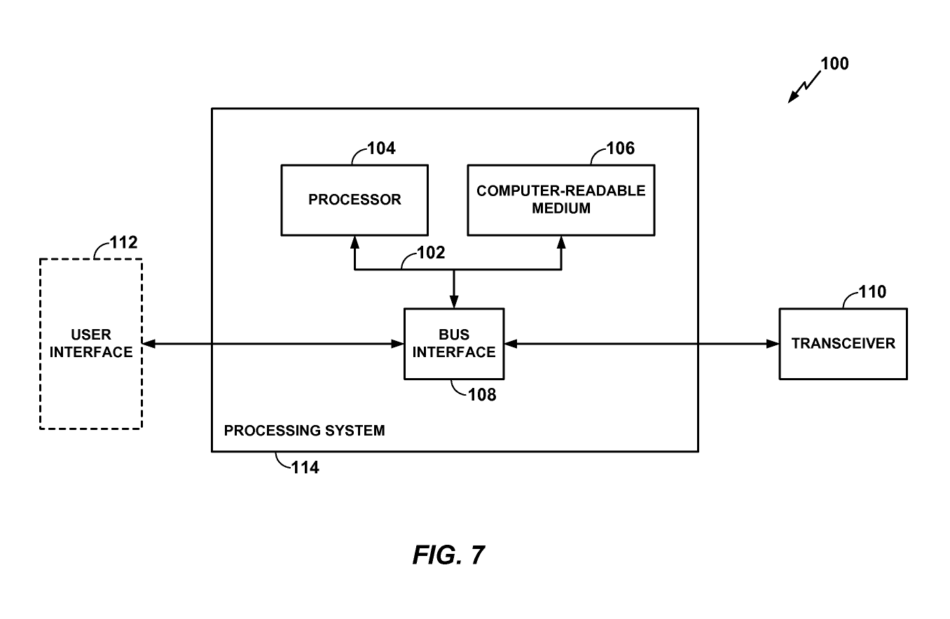

FIG. 7 is a block diagram illustrating an example of a hardware implementation for an apparatus 100 employing a processing system 114. In an aspect, apparatus 100 may be RNC 2000 of FIG. 1 and may be capable of transmitting accelerated TCP packet ACK messages to a server. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

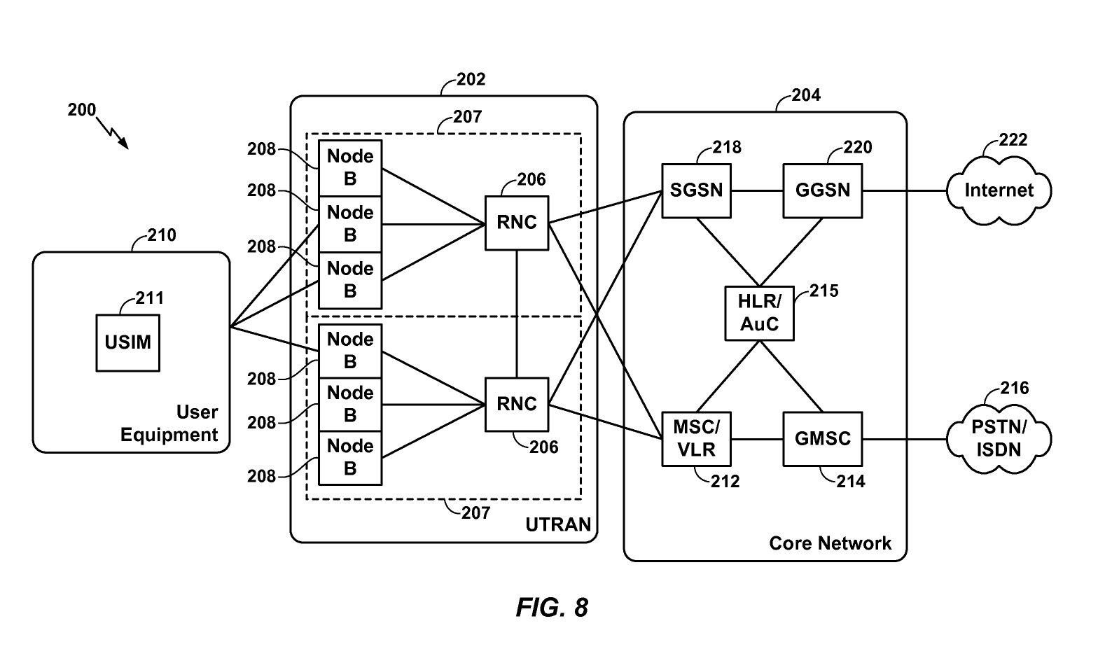

The various concepts presented throughout this disclosure may be implemented across a broad variety of telecommunication systems, network architectures, and communication standards. By way of example and without limitation, the aspects of the present disclosure illustrated in FIG. 8 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In an aspect, UE 210 may correspond to UE 4000 of FIG. 1. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. In an aspect, each RNC 206 may correspond to RNC 2000 of FIG. 1. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI. “HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another. On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

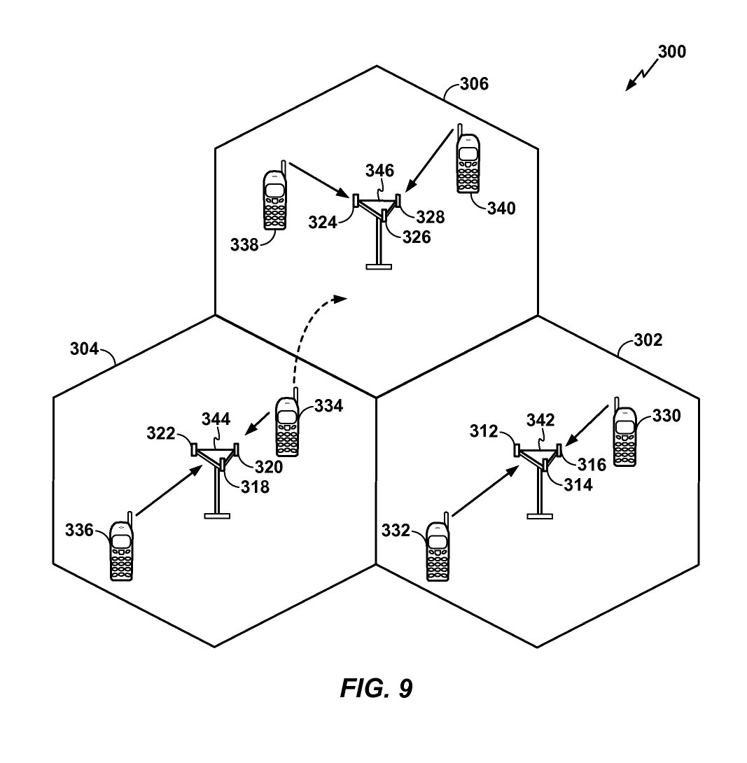

Referring to FIG. 9, an access network 300 in a UTRAN architecture is illustrated, which may allow for utilization of accelerated TCP ACK message transmission to reduce round trip time for TCP packets. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306, and may correspond to UE 4000. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 8) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 8), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

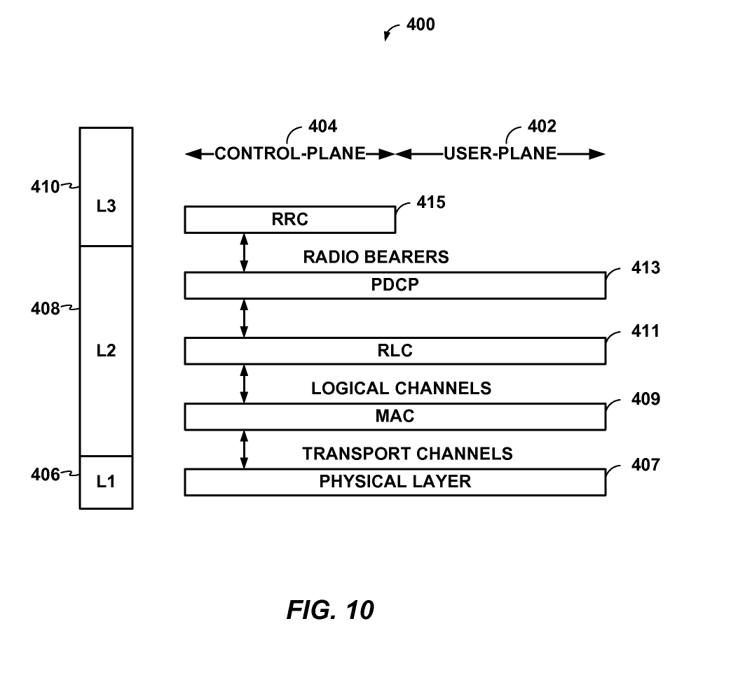

The radio protocol architecture may take on various forms depending on the particular application. An example for an HSPA system will now be presented with reference to FIG. 10.

Referring to FIG. 10, an example radio protocol architecture 400 relates to the user plane 402 and the control plane 404 of a user equipment (UE) or node B/base station. For example, architecture 400 may be included in a UE such as UE 4000 (FIG. 1). The radio protocol architecture 400 for the UE and node B is shown with three layers: Layer 1 406, Layer 2 408, and Layer 3 410. Layer 1 406 is the lowest lower and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

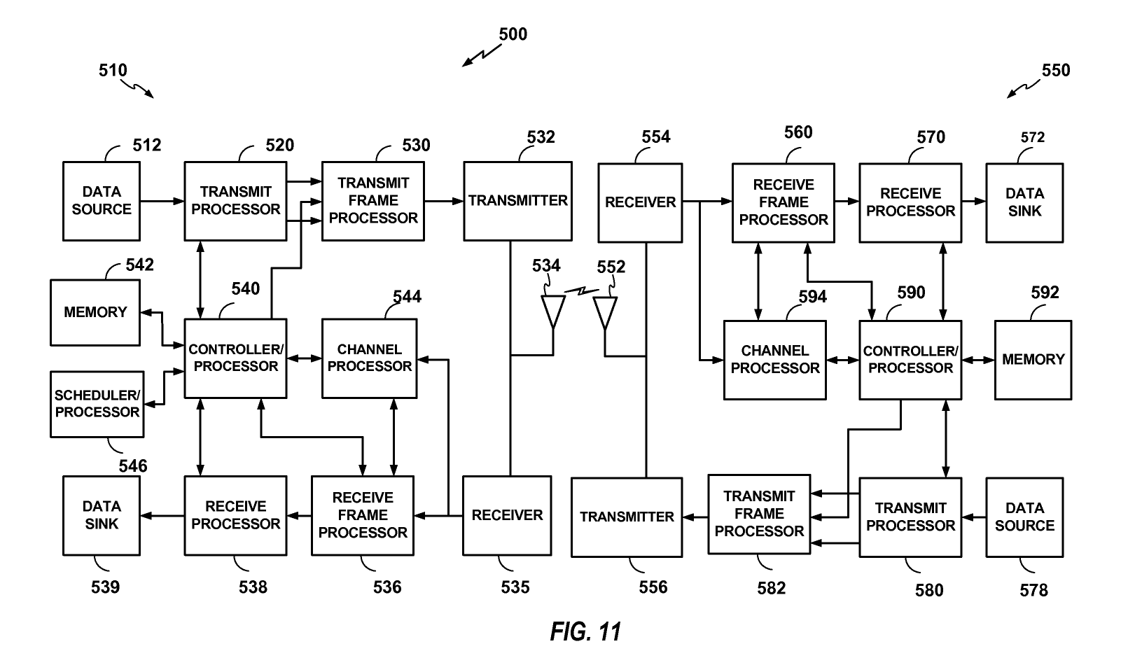

FIG. 11 is a block diagram of a Node B 510 in communication with a UE 550, where the Node B 510 may be the base station 3000 in FIG. 1, and the UE 550 may be the UE 4000 in FIG. 1. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving, at a radio network controller (RNC), a transmission control protocol (TCP) packet for a user equipment (UE) from a server;
reforming the TCP packet into a set of radio link control (RLC) packets;
transmitting the set of RLC packets to a base station; and
sending an accelerated TCP acknowledgement message to the server based on the transmitting of the set of RLC packets to the base station.

2. The method of claim 1, wherein sending the accelerated TCP acknowledgement message further comprises sending with a previously-determined window size parameter.

3. The method of claim 2, further comprising:
intercepting a TCP connection establishment phase and storing an initial UE advertised window size parameter, wherein the initial UE advertised window size parameter comprises the previously-determined window size parameter; and
wherein sending the accelerated TCP acknowledgement message further comprises sending with the initial UE advertised window size.

4. The method of claim 2, further comprising:
receiving, at the RNC, an acknowledgement message corresponding to a prior TCP packet sent to the UE, wherein the acknowledgement message includes a window size parameter, wherein the window size parameter comprises the previously-determined window size parameter; and
wherein sending the accelerated TCP acknowledgement message further comprises sending with the window size parameter.

5. The method of claim 1, further comprising receiving, at the RNC, a TCP acknowledgement message corresponding to the TCP packet, wherein the TCP acknowledgement message is received after the sending of the accelerated TCP acknowledgement message to the server.

6. The method of claim 1, further comprising:
saving the TCP packet at the RNC in an RNC memory;
receiving, at the RNC, a TCP acknowledgement message corresponding to the TCP packet; and
discarding the TCP packet from the RNC memory.

7. The method of claim 1, further comprising:
receiving, at the RNC, a TCP acknowledgement message corresponding to the TCP packet, wherein the TCP acknowledgement message comprises at least a window size parameter and TCP packet acknowledgement information
updating a TCP acknowledgement sequence number based on the TCP packet acknowledgement information;
discarding the TCP packet acknowledgement data;
storing the window size parameter and the updated TCP acknowledgement sequence number; and
transmitting uplink data to the server when the TCP acknowledgement message further comprises the uplink data.

8. The method of claim 1, further comprising:
saving the TCP packet at the RNC in an RNC memory;
receiving multiple TCP acknowledgement messages from the UE corresponding to the same TCP packet;
reading the TCP packet corresponding to the multiple TCP acknowledgement messages from the RNC memory based on the receiving of the multiple UE acknowledgement messages;
reforming the TCP packet read from the memory into a new set of RLC packets; and
transmitting the new set of RLC packets to the base station.

9. The method of claim 1, further comprising:
saving the TCP packet at the RNC in an RNC memory;
determining that an RLC reset condition exists;
reading the TCP packet corresponding to a previously-received UE acknowledgement message from the RNC memory based on determining that the RLC reset condition exists;
reforming the TCP packet read from the memory into a new set of RLC packets; and
transmitting the new set of RLC packets to the base station.

10. The method of claim 1, further comprising performing a TCP-RLC correlation function to TCP packets and corresponding RLC PDU packets associated with in response to establishing a TCP connection between the server and the UE.

11. The method of claim 1, further comprising:
operating an RLC layer according to an RLC reset procedure configured to re-initiate retransmissions of an RLC packet when a configured maximum number of transmissions of the RLC packet is reached; and
wherein sending the accelerated TCP acknowledgement message is based on the operating of the RLC layer according to the RLC reset procedure.

12. An apparatus for wireless communication, comprising:
means for receiving, at a radio network controller (RNC), a transmission control protocol (TCP) packet for a user equipment (UE) from a server;
means for reforming the TCP packet into a set of radio link control (RLC) packets;
means for transmitting the set of RLC packets to a base station; and
means for sending an accelerated TCP acknowledgement message to the server based on the transmitting of the set of RLC packets to the base station.

13. The apparatus of claim 12, wherein means for sending the accelerated TCP acknowledgement message comprises sending with a previously-determined window size parameter.

14. The apparatus of claim 13, further comprising:
means for intercepting a TCP connection establishment phase and means for storing an initial UE advertised window size parameter, wherein the initial UE advertised window size parameter comprises the previously-determined window size parameter; and
wherein means for sending the accelerated TCP acknowledgement message comprises sending with the initial UE advertised window size.

15. The apparatus of claim 13, further comprising:
means for receiving, at the RNC, an acknowledgement message corresponding to a prior TCP packet sent to the UE, wherein the acknowledgement message includes a window size parameter, wherein the window size parameter comprises the previously-determined window size parameter; and
wherein means for sending the accelerated TCP acknowledgement message comprises sending with the window size parameter.

16. The apparatus of claim 12, further comprising means for receiving, at the RNC, a TCP acknowledgement message corresponding to the TCP packet, wherein the TCP acknowledgement message is received after the sending of the accelerated TCP acknowledgement message to the server.

17. The apparatus of claim 12, further comprising:
means for saving the TCP packet at the RNC in an RNC memory;
means for receiving, at the RNC, a TCP acknowledgement message corresponding to the TCP packet; and
means for discarding the TCP packet from the RNC memory.

18. The apparatus of claim 12, further comprising:
means for receiving, at the RNC, a TCP acknowledgement message corresponding to the TCP packet, wherein the TCP acknowledgement message comprises at least a window size parameter and TCP packet acknowledgement information
means for updating a TCP acknowledgement sequence number based on the TCP packet acknowledgement information;
means for discarding the TCP packet acknowledgement data;
means for storing the window size parameter and the updated TCP acknowledgement sequence number; and
means for transmitting uplink data to the server when the TCP acknowledgement message further comprises the uplink data.

19. The apparatus of claim 12, further comprising:
means for saving the TCP packet at the RNC in an RNC memory;
means for receiving multiple TCP acknowledgement messages from the UE corresponding to the same TCP packet;
means for reading the TCP packet corresponding to the multiple TCP acknowledgement messages from the RNC memory based on the receiving of the multiple UE acknowledgement messages;
means for reforming the TCP packet read from the memory into a new set of RLC packets; and
means for transmitting the new set of RLC packets to the base station.

20. The apparatus of claim 12, further comprising:
means for saving the TCP packet at the RNC in an RNC memory;
means for determining that an RLC reset condition exists;
means for reading the TCP packet corresponding to a previously-received UE acknowledgement message from the memory based on determining that the RLC reset condition exists;
means for reforming the TCP packet read from the RNC memory into a new set of RLC packets; and
means for transmitting the new set of RLC packets to the base station.

21. The apparatus of claim 12, further comprising means for performing a TCP-RLC correlation function to TCP packets and corresponding RLC PDU packets associated with in response to establishing a TCP connection between the server and the UE.

22. The apparatus of claim 12, further comprising:
means for operating an RLC layer according to an RLC reset procedure configured to re-initiate retransmissions of an RLC packet when a configured maximum number of transmissions of the RLC packet is reached; and
wherein means for sending the accelerated TCP acknowledgement message is based on the operating of the RLC layer according to the RLC reset procedure.

23. A computer program product, comprising:
a computer-readable medium comprising code for:
receiving, at a radio network controller (RNC), a transmission control protocol (TCP) packet for a user equipment (UE) from a server;
reforming the TCP packet into a set of radio link control (RLC) packets;
transmitting the set of RLC packets to a base station; and
sending an accelerated TCP acknowledgement message to the server based on the transmitting of the set of RLC packets to the base station.

24. The computer program product of claim 23, wherein the computer-readable medium further comprises code for sending the accelerated TCP acknowledgement message and comprises sending with a previously-determined window size parameter.

25. The computer program product of claim 24, wherein the computer-readable medium further comprises code for:
intercepting a TCP connection establishment phase and storing an initial UE advertised window size parameter, wherein the initial UE advertised window size parameter comprises the previously-determined window size parameter; and
wherein the code for sending the accelerated TCP acknowledgement message comprises sending with the initial UE advertised window size.

26. The computer program product of claim 24, wherein the computer-readable medium further comprises code for:
receiving, at the RNC, an acknowledgement message corresponding to a prior TCP packet sent to the UE, wherein the acknowledgement message includes a window size parameter, wherein the window size parameter comprises the previously-determined window size parameter; and
wherein the code for sending the accelerated TCP acknowledgement message comprises sending with the window size parameter.

27. The computer program product of claim 23, wherein the computer-readable medium further comprises code for receiving, at the RNC, a TCP acknowledgement message corresponding to the TCP packet, wherein the TCP acknowledgement message is received after the sending of the accelerated TCP acknowledgement message to the server.

28. The computer program product of claim 23, wherein the computer-readable medium further comprises code for:
saving the TCP packet at the RNC in an RNC memory;
receiving, at the RNC, a TCP acknowledgement message corresponding to the TCP packet; and
discarding the TCP packet from the RNC memory.

29. The computer program product of claim 23, wherein the computer-readable medium further comprises code for:
receiving, at the RNC, a TCP acknowledgement message corresponding to the TCP packet, wherein the TCP acknowledgement message comprises at least a window size parameter and TCP packet acknowledgement information
updating a TCP acknowledgement sequence number based on the TCP packet acknowledgement information;
discarding the TCP packet acknowledgement data;
storing the window size parameter and the updated TCP acknowledgement sequence number; and
transmitting uplink data to the server when the TCP acknowledgement message further comprises the uplink data.

30. The computer program product of claim 23, wherein the computer-readable medium further comprises code for:
saving the TCP packet at the RNC in an RNC memory;
receiving multiple TCP acknowledgement messages from the UE corresponding to the same TCP packet;
reading the TCP packet corresponding to the multiple TCP acknowledgement messages from the RNC memory based on the receiving of the multiple UE acknowledgement messages;
reforming the TCP packet read from the memory into a new set of RLC packets; and
transmitting the new set of RLC packets to the base station.

31. The computer program product of claim 23, wherein the computer-readable medium further comprises code for:
saving the TCP packet at the RNC in an RNC memory;
determining that an RLC reset condition exists;
reading the TCP packet corresponding to a previously-received UE acknowledgement message from the RNC memory based on determining that the RLC reset condition exists;
reforming the TCP packet read from the memory into a new set of RLC packets; and
transmitting the new set of RLC packets to the base station.

32. The computer program product of claim 23, wherein the computer-readable medium further comprises code for performing a TCP-RLC correlation function to TCP packets and corresponding RLC PDU packets associated with in response to establishing a TCP connection between the server and the UE.

33. The computer program product of claim 23, wherein the computer-readable medium further comprises code for:
operating an RLC layer according to an RLC reset procedure configured to re-initiate retransmissions of an RLC packet when a configured maximum number of transmissions of the RLC packet is reached; and
wherein the code for sending the accelerated TCP acknowledgement message is based on the operating of the RLC layer according to the RLC reset procedure.

34. An apparatus for wireless communication, comprising:
at least one processor; and
a memory coupled to the at least one processor, wherein the at least one processor is configured to:
receive, at a radio network controller (RNC), a transmission control protocol (TCP) packet for a user equipment (UE) from a server;
reform the TCP packet into a set of radio link control (RLC) packets;
transmit the set of RLC packets to a base station; and
send an accelerated TCP acknowledgement message to the server based on the transmitting of the set of RLC packets to the base station.

35. The apparatus of claim 34, wherein the at least one processor configured to send the accelerated TCP acknowledgement message is further configured to send the accelerated TCP acknowledgement message with a previously-determined window size parameter.

36. The apparatus of claim 35, wherein the at least one processor is further configured to:
intercept a TCP connection establishment phase and store an initial UE advertised window size parameter, wherein the initial UE advertised window size parameter comprises the previously-determined window size parameter; and
wherein the at least one processor configured to send the accelerated TCP acknowledgement message is further configured to send the accelerated TCP acknowledgement message with the initial UE advertised window size.

37. The apparatus of claim 35, wherein the at least one processor is further configured to:
receive, at the RNC, an acknowledgement message corresponding to a prior TCP packet sent to the UE, wherein the acknowledgement message includes a window size parameter, wherein the window size parameter comprises the previously-determined window size parameter; and
wherein the at least one processor configured to send the accelerated TCP acknowledgement message is further configured to send the accelerated TCP acknowledgement message with the window size parameter.

38. The apparatus of claim 34, wherein the at least one processor is further configured to receive, at the RNC, a TCP acknowledgement message corresponding to the TCP packet, wherein the TCP acknowledgement message is received after the sending of the accelerated TCP acknowledgement message to the server.

39. The apparatus of claim 34, wherein the at least one processor is further configured to:
save the TCP packet at the RNC in an RNC memory;
receive, at the RNC, a TCP acknowledgement message corresponding to the TCP packet; and
discard the TCP packet from the RNC memory.

40. The apparatus of claim 34, wherein the at least one processor is further configured to:
receive, at the RNC, a TCP acknowledgement message corresponding to the TCP packet, wherein the TCP acknowledgement message comprises at least a window size parameter and TCP packet acknowledgement information
update a TCP acknowledgement sequence number based on the TCP packet acknowledgement information;
discard the TCP packet acknowledgement data;
store the window size parameter and the updated TCP acknowledgement sequence number; and
transmit uplink data to the server when the TCP acknowledgement message further comprises the uplink data.

41. The apparatus of claim 34, wherein the at least one processor is further configured to:
save the TCP packet at the RNC in an RNC memory;
receive multiple TCP acknowledgement messages from the UE corresponding to the same TCP packet;
read the TCP packet corresponding to the multiple TCP acknowledgement messages from the RNC memory based on the receiving of the multiple UE acknowledgement messages;
reform the TCP packet read from the memory into a new set of RLC packets; and
transmit the new set of RLC packets to the base station.

42. The apparatus of claim 34, wherein the at least one processor is further configured to:
save the TCP packet at the RNC in an RNC memory;
determine that an RLC reset condition exists;
read the TCP packet corresponding to a previously-received UE acknowledgement message from the RNC memory based on determining that the RLC reset condition exists;
reform the TCP packet read from the memory into a new set of RLC packets; and
transmit the new set of RLC packets to the base station.

43. The apparatus of claim 34, wherein the at least one processor is further configured to perform a TCP-RLC correlation function to TCP packets and corresponding RLC PDU packets associated with in response to establishing a TCP connection between the server and the UE.

44. The apparatus of claim 34, wherein the at least one processor is further configured to:
operate an RLC layer according to an RLC reset procedure configured to re-initiate retransmissions of an RLC packet when a configured maximum number of transmissions of the RLC packet is reached; and
wherein the at least one processor configured to send the accelerated TCP acknowledgement message is based on the operating of the RLC layer according to the RLC reset procedure.
